(19) United States
(12) Patent Application Publication
(10) Pub. No.: US 2019/0366191 A1
(43) Pub. Date: Dec. 5, 2019

(54) COMPUTER PROGRAM PRODUCT, PROCESS, AND USER INTERFACE FOR ENTRY OF VOLLEYBALL STATISTICS

(71) Applicant: DemiVision LLC, Huntington Beach, CA (US)

(72) Inventor: Barry Sohl, Huntington Beach, CA (US)

(21) Appl. No.: 16/426,766

(22) Filed: May 30, 2019

Related U.S. Application Data
(60) Provisional application No. 62/677,791, filed on May 30, 2018.

(51) Int. Cl. A63B 71/06; G06F 3/0488; G06F 3/0482

(52) U.S. Cl. CPC A63B 71/0669; G06F 3/04883; A63B 2071/0694; G06F 2203/04803; A63B 2243/0095; G06F 3/0482

(57) ABSTRACT

A volleyball statistic keeping user interface provides rapid identification of players and volleyball actions without needing to display pre-set buttons for every player currently on the court. In some embodiments, a virtual court representing a volleyball court is generated. A state machine determines the most likely volleyball action to occur at any point in the virtual court during gameplay. Thus, when a user selects a location in the virtual court, the state machine automatically triggers a highest probable action for the location which may be confirmed by the user and the statistic is automatically logged into the record. The entire process may occur in split seconds allowing the user intuitive touch and record keeping alongside the pace of real-time volleyball play.

### CROSS-REFERENCE TO RELATED APPLICATIONS

This application claims benefit under 35 U.S.C. § 119(e) of U.S. Provisional Application having Ser. No. 62/677,791 filed May 30, 2018, which is hereby incorporated by reference herein in its entirety.

### FIELD

The subject disclosure relates to graphical displays and more particularly to a computer program product, process, and user interface for entry of volleyball statistics.

### BACKGROUND

Like with most sports, statistics are an important part of the sport of volleyball. They are used to objectively and quantitatively measure player performance, to provide feedback to users, to affect training and player development, and to make strategic decisions during a match. Volleyball statistics can also be useful for fans and media following the sport.

An example of common volleyball statistics includes the following. This list is only a very small sample of the hundreds of possible statistics:

Hitting Percentage—measures efficiency of attack offense.

Aces Per Set—measures direct points on serve.

Serve Rating—measures the difficulty of serves.

Sideout Percentage—measures the effectiveness of serve receive offense.

Playing Time—measures level of player participation by time or points.

Recording statistics for volleyball can be very challenging. It is an extremely fast-paced and deceptively complex sport. There have historically been two fundamental problems for recording volleyball statistics: pace of play and the required volleyball knowledge.

Pace of Play

Volleyball is an extremely fast-paced sport. When played at a high-level, each ball contact occurs in rapid succession. Several contacts can occur within the span of just a few seconds. Because of the very high pace of play, the statistician must be able to input data at an extremely high rate of entry. This can be challenging for even the most experienced statistician, and outright impossible for many novice statisticians. This becomes even more challenging if the data set adds more sophisticated data (for example, shot type, court location, etc.). Not being able to keep up with the pace of play results in inaccurate data or entirely missed data.

There are generally one or more problems in the technology to quickly and accurately enter volleyball statistics. The problems have traditionally been addressed in one of a few approaches:

Input statistics from a video recording of the match after-the-fact. This gives the statistician the ability to pause and resume, to slow the pace of play. However, the statistics are only available well after a match is finished and sometimes days after. The approach loses the ability for coaches to have real-time statistics for making strategic decisions during the match, or for providing player feedback shortly after the match. It also prevents fans from following stats live during the match.

Using multiple statisticians, one calling out the action, while the other inputs data. Or using multiple statisticians with each only inputting a subset of the data. These approaches can help but involve additional personnel and equipment. Many teams do not have access to those resources.

Reducing the amount of data collected. If the statistician only records a few data points, such as serves and hits, it can simplify the recording process. The obvious tradeoff is a significant reduction in the depth of data and its usefulness in decision making for the coach.

Volleyball Knowledge

Another traditional impediment to recording accurate volleyball statistics has been the amount of volleyball knowledge required. Like most sports, volleyball has its own set of rules and terminology that may seem esoteric to the uninitiated. And there is generally not as much understanding of volleyball among the general populace as with other more mainstream sports such as baseball or basketball. Recording volleyball stats accurately usually requires a fairly deep knowledge of volleyball and its rules. For example:

When is a defensive pass technically not a dig?

What is the official definition of a kill?

When is an error considered a Ball Handling Error (BHE)?

When a team serves out of rotation, who receives the error?

Statisticians are often volunteer students or parents with limited volleyball knowledge. The result is statistics that are inaccurately recorded or missed entirely or that include subjective interpretations. Inaccurate data can sometimes be worse than no data at all as they can lead to misinformed decisions. These accuracy issues also severely limit the ability to compare stats consistently across teams, leagues, or even between statisticians from the same team.

Traditionally, this volleyball knowledge limitation can only be addressed through increased practice with the data entry method or with extensive time and experience around the sport of volleyball.

Prior to the advent of downloadable software for mobile devices, entry of volleyball statistics traditionally involved recording tally marks with pencil and paper. The tallies were then summed and calculated into the desired statistics, or they were manually entered into a computer-based spreadsheet application. There were also computer-based applications, but they involved having a bulky laptop computer court-side. The interface mechanism was slow and cumbersome using a mouse, and the software was very expensive. Typically, only large colleges used this approach.

Small and light mobile devices, combined with downloadable “apps”, enabled a much less expensive and more efficient mechanism for recording statistics. iStatVball was one of the first mobile apps to apply this new approach to the sport of volleyball more than eight years ago. It was a revolutionary user interface at the time. Since then, multiple competitors have entered the market, but the basic interface approach offered by all the apps has changed very little.

Referring now to FIGS. 1-4, a few examples of available volleyball statistics interfaces are shown. Essentially most if not all volleyball statistics applications today have some variation of the same interface. They require that the user select a player responsible for a particular volleyball action, and then they require that the user tap (or click) a button labeled for that action (serve, attack, etc.). FIGS. 1, 3, and 4 show this type of interface process. This can sometimes be combined into a single action. The user interface usually consists of a complex array of buttons from which the user must choose the correct one in a split second during the match. FIGS. 1 and 3 for example show complex interfaces with several buttons from which a selection is required in split-second timespans. FIG. 1 in particular shows a user interface for each player currently on the court and several different buttons for each player, some of which have no applicability to the players' current position on the court. As can be seen, certain actions are repeated for each player consuming valuable UI space, crowding the touch screen. As may be appreciated, this may convolute the screen and add time to identifying the correct button to press during a rapid pace of gameplay. FIG. 3 shows a user interface (UI) which adds buttons but lacks any relationship of the recorded stat to a location on the court. This approach lacks a meaningful nexus between the action and the context of the play.

If the number of buttons is reduced to increase ease of user friendliness, the depth of stat data collected is severely reduced. FIGS. 2 and 4 show other examples of volleyball statistic entry during gameplay which have less buttons to record statistics than for example the interfaces of FIGS. 1 and 3. FIG. 2 shows a (UI) which reduces the number of buttons at the expense of depth of data. FIG. 4 shows a UI which shows players by their general starting area in the court during serve along with esoteric volleyball acronyms.

This complex array of buttons does not solve either of the fundamental problems with recording volleyball stats. Finding and tapping the correct button or multiple buttons is still extremely difficult given the fast pace of play and timeframe to enter and still observe the action. And the array of buttons with esoteric volleyball terminology and abbreviations still requires advanced volleyball knowledge to use correctly.

As can be seen, there is a need for a user interface system that provides quick and accurate entry of volleyball statistics during live game action.

### SUMMARY

In one aspect of the disclosure, a computer program product for generating a user interface (UI) for rapid entry of volleyball statistics in real-time comprises a non-transitory computer readable storage medium having computer readable program code. The computer readable program code is configured, when executed by a processor, to: provide the UI on a computing device with an electronic display; generate a virtual court area in the UI, the virtual court area representing a virtual volleyball court; identify an input in the electronic display received from a user, of a location in the virtual volleyball court touched by the user wherein the location in the virtual volleyball court corresponds to a real-life location of a volleyball play on a real-life volleyball court; determine by the processor, a volleyball action, from a set of finite volleyball actions possible at the location in the virtual volleyball court touched by the user; and automatically record a volleyball statistic for the determined volleyball action.

In another aspect a method for generating a user interface (UI) for rapid entry of volleyball statistics in real-time comprises providing the UI on a computing device with an electronic display; generating a virtual court area in the UI, the virtual court area representing a virtual volleyball court; identifying an input in the electronic display received from a user, of a location in the virtual volleyball court touched by the user wherein the location in the virtual volleyball court corresponds to a real-life location of a volleyball play on a real-life volleyball court; determining by the processor, a volleyball action, from a set of finite volleyball actions possible at the location in the virtual volleyball court touched by the user; and automatically recording a volleyball statistic for the determined volleyball action.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIGS. 1-4 are various diagrammatic views of mobile computing device screenshots of electronic interfaces for volleyball statistical entries according to the prior art.

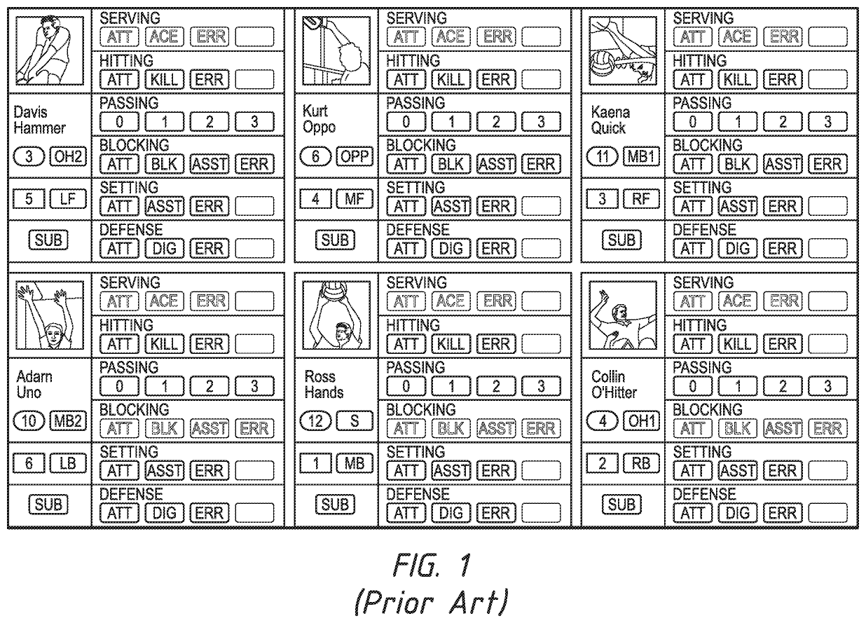

FIGS. 5 is a diagrammatic screenshot representation of a virtual volleyball court electronic user interface for entry of volleyball statistics in accordance with embodiments of the subject technology.

FIG. 6 is a diagrammatic screenshot representation of the virtual volleyball court electronic user interface of FIG. 5 in a horizontally displayed orientation sans a pop-up window present in FIG. 5 being shown.

FIG. 7 is a diagrammatic screenshot representation of the virtual volleyball court electronic user interface of FIG. 5 in a vertically displayed orientation according to an embodiment.

FIG. 8 is a flowchart of a process for automatically determining a volleyball statistic to record in a user interface in accordance with embodiments.

FIG. 9 is a flowchart of a process for automatically determining transitions between volleyball actions for recording statistics in a user interface according to an exemplary embodiment.

FIG. 10 is a diagrammatic view of a screenshot representation of a shot chart in accordance with embodiments of the subject technology.

FIG. 11 is a diagrammatic view of a screenshot representation of a heat map in accordance with embodiments of the subject technology.

FIG. 12 is a diagrammatic view of a screenshot representation of a block zone in the virtual volleyball court of FIG. 5 for features triggered by touching the UI near the net area in accordance with embodiments of the subject technology.

FIG. 13 is a diagrammatic view of a screenshot representation of the virtual volleyball court of FIG. 5 tracking the location of ball actions in accordance with embodiments of the subject technology.

FIG. 14 is a flowchart of a machine learning process for predicting a player to list for a volleyball action in a user interface for recording volleyball statistics in accordance with embodiments according to an exemplary embodiment.

FIG. 15 is a diagrammatic representation for generating a display of a player selection based on weighted variables in a machine learning process in accordance with embodiments.

FIG. 16 is a diagrammatic representation of lists of players displayed in a user interface by priority based on weighted variables in accordance with embodiments.

FIG. 17 is a screenshot representation of a virtual court and a user selection window utilizing a tap and drag feature in accordance with an exemplary embodiment.

FIG. 18 is a block diagram of a computer/server system for generating and controlling a virtual volleyball court electronic user interface for entry of volleyball statistics in accordance with aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, embodiments of the subject technology provide an improvement to electronic Uls for statistical entry of plays which represents a complete paradigm shift for the input of, for example, volleyball statistics. In some embodiments, the product may be known as “RallyFlow” and embodiments may sometimes be referred to interchangeably and generally as part of the “RallyFlow” system. Aspects of the embodiments disclosed automatically determine statistics based on the location of a user touch in a virtual playing field (for example, a virtual court as may be seen in volleyball, tennis, badminton or similar court-based activities). User interaction with the virtual location may allow more data to be recorded at a faster speed than any prior solution. This occurs while requiring less sport-specific knowledge than ever before. As will be appreciated, the user interaction with location specific selections of the virtual playing field provides a practical application to data entry by registering the location selected and determining from the location one of a number of play actions that may have occurred. Furthermore, the play action may be recorded and translated into a statistic in real-time so that accurate scorekeeping may be achieved and game play analysis may be readily available. There are three aspects disclosed in more detail below that help provide solutions to the aforementioned identified problems: a virtual court display with interactive touch registration and location identification; a machine learning background process; and a tap and drag mechanic in the user interface.

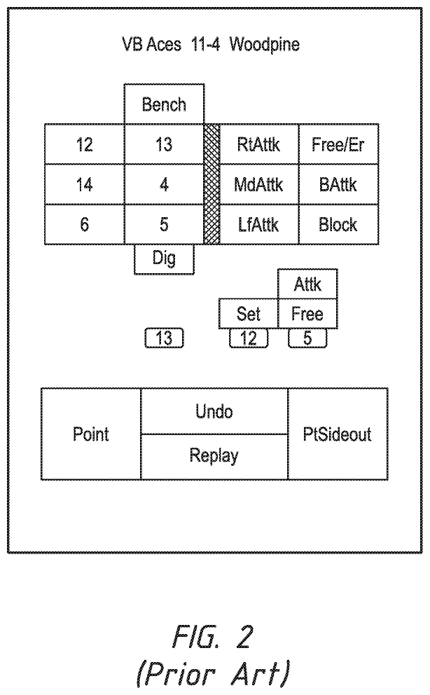

Referring to FIGS. 5-14, various screenshots of an electronic user interface for a statistic entry application are shown according to exemplary embodiments of the present disclosure. The following will be described in the context of the sport of volleyball for sake of illustration. However, it will be understood that aspects of the embodiments disclosed below may be modified and applied to other sports/activities and may still be within the scope of the invention contemplated.

Virtual Court

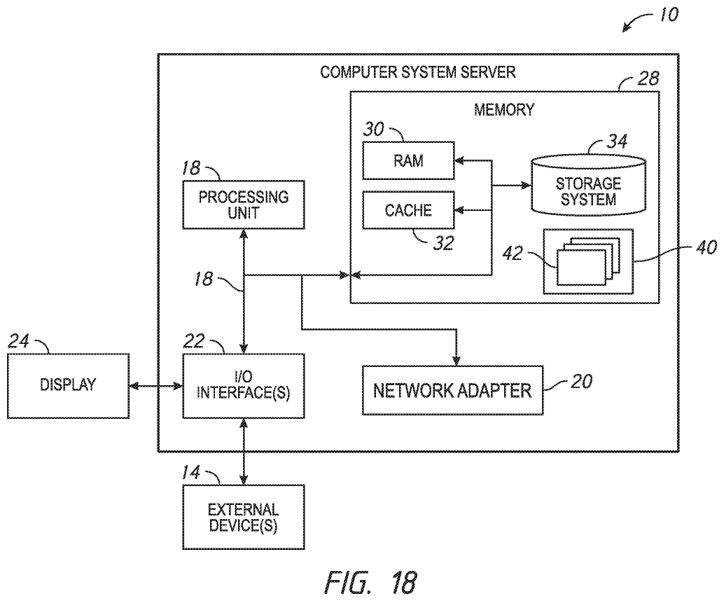

FIGS. 5-11 show embodiments related to an electronic UI 100 a virtual playing field 110. The electronic UI 100 may be accessed through an electronic display of a computing device (details and examples of which are disclosed below with reference to FIG. 18). In some embodiments, the electronic UI 100 may be a computer program product executed by the computing device. In an exemplary embodiment, an electronic display showing the electronic UI 100 may be a touch-sensitive display (for example, a capacitance-based screen) which registers the exact location of touch by a user. Consistent with the description, the virtual playing field 110 may be configured to represent a volleyball court and may be interchangeable be referred to as the virtual volleyball court 110 (or “virtual court 110”) as compared to the broader embodiment of a virtual playing field 110. Thus, the primary user interface design for inputting volleyball stats may be a scale representation of a volleyball court.

Referring to FIGS. 5-7, the virtual court 110 in the interface display may be arranged to exactly mirror what the user is seeing in front of them. For example, the virtual court 110 may include an out-of-bounds area 105 along the perimeter of the virtual court 110. A first team's side 120 of the court may be partitioned off from a second team's side 130 of the court by a virtual net 140 which may be positioned over where the centerline of a court would be. Each side of the virtual court 110 may include demarcated areas representing a limited number of gameplay actions being available. For example, each side of the virtual court 110 may include a block zone 145 adjacent the virtual net 140 (and generally within 1 foot of the net), a front row area 160 which may comprise the block zone 145 and extend away from the net 140 to a line representing the attack line. Beyond the attack line, (for example, extending farther from than net 140 than the front row area 160 and up to an end line) may be a back row area 170. A touch of the user in any of the elements in the virtual court 110 may trigger a pop-up window 130 with selectable players and/or gameplay actions. The selectable options displayed in the pop-up window 130 may be based on the location touched.

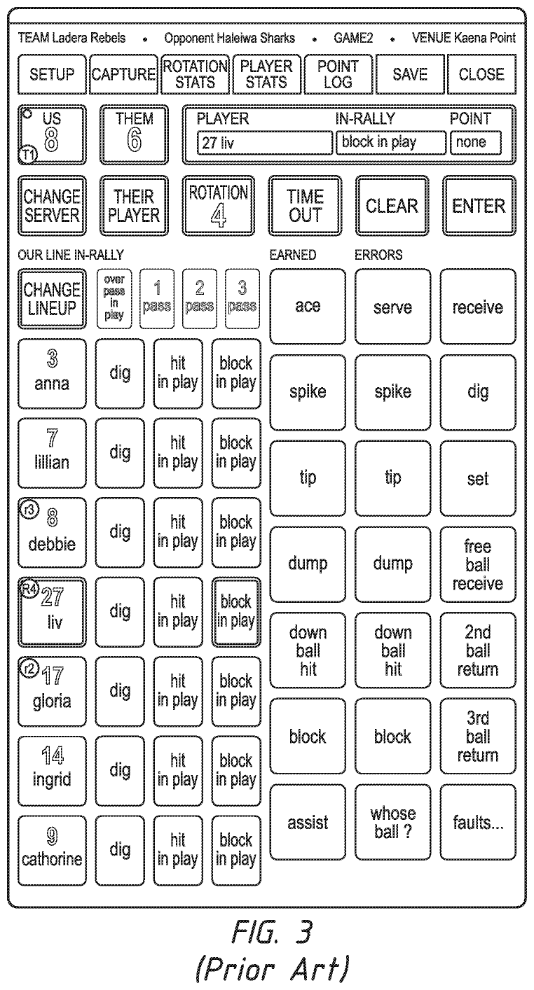

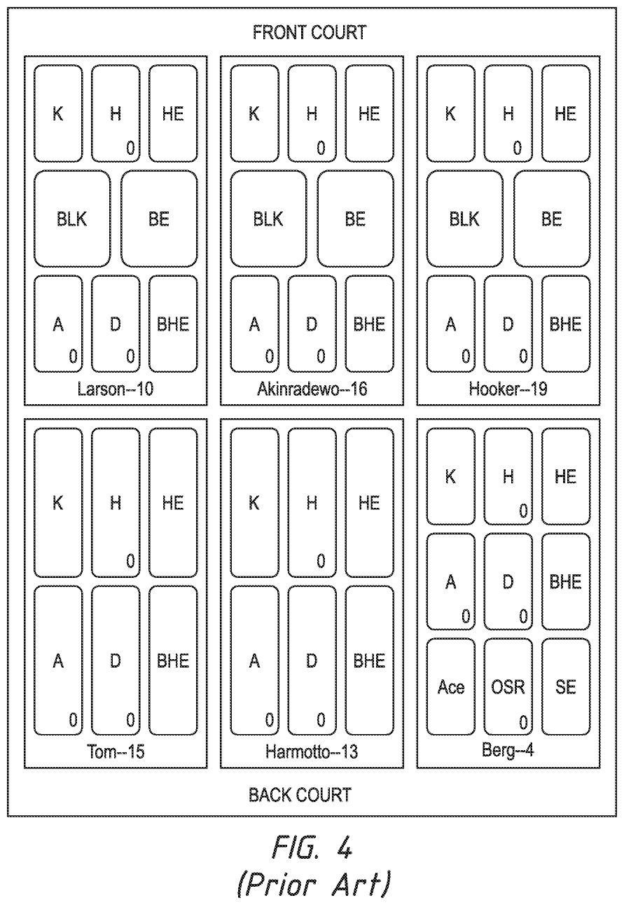

In some embodiments, the user may change the orientation of the virtual court 110 to match their relationship perspective, for example, where they are sitting alongside the real court or in the stands. See for example, FIGS. 6-7 which show both horizontal (FIG. 6) and vertical (FIG. 7) orientations so that sideline and end line perspectives are available from the user's perspective. As will be appreciated, supporting both orientations eliminates the need for the user to mentally translate the geometry in their head between what they see on the real court in front of them and what they enter on the virtual court 110.

To input statistics, the user may tap on the virtual court 110 whenever a volleyball action occurs at the location where it occurred. In this case, a volleyball action would be anytime a player touches the ball or the ball lands on the real court surface. The user then selects the player responsible for that action from a list provided by the system at the location where the user tapped. As may be appreciated, the user does not have to specifically select a “Kill”, or “Ace”, or “Dig” button or decide when those may or may not technically be correct because the background process may automatically determine the action. There is almost no volleyball knowledge required. And there is no hunting around a screen full of buttons for the correct tap. The only required tap is at the location where they see the ball on the court in front of them in real life.

State Machine

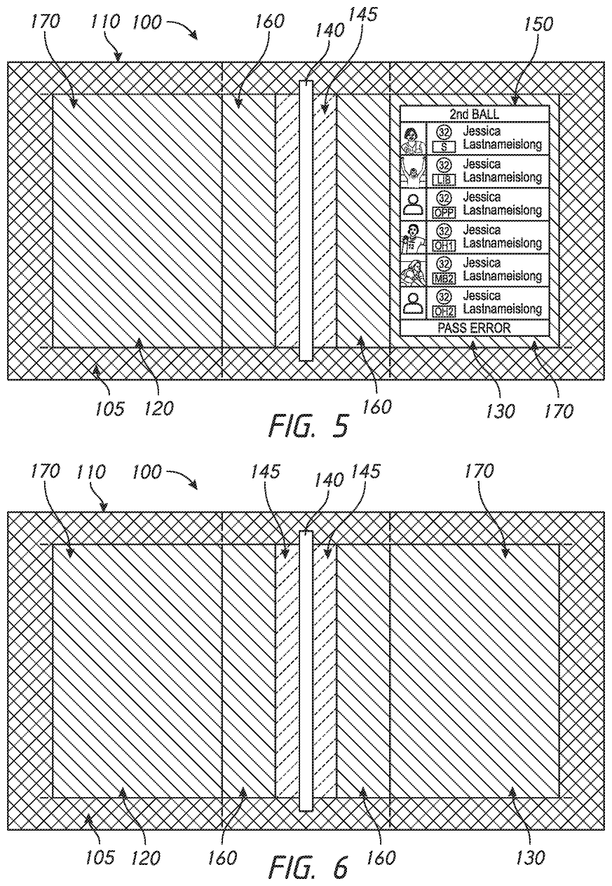

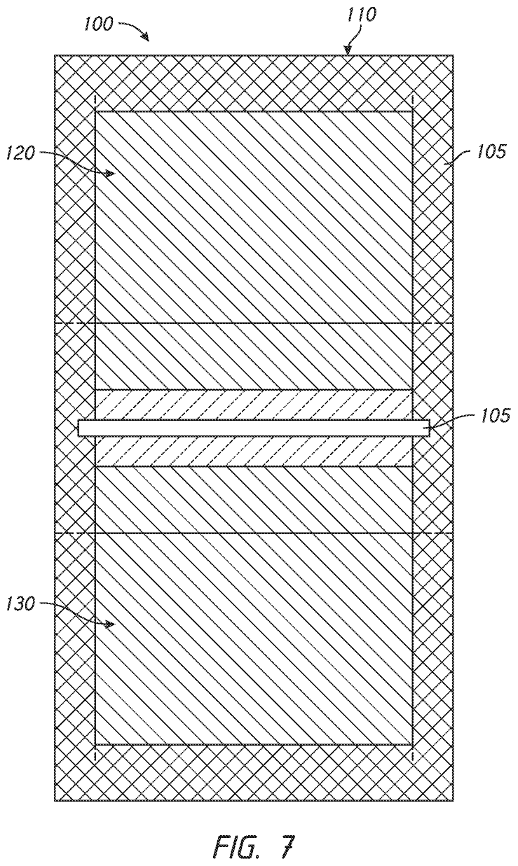

Referring now to FIGS. 8-9, this sophisticated, yet easy to use approach, is made possible using for example, a complex, internal state machine. As it turns out, the sport of volleyball can be represented as a finite state machine. FIG. 8 shows a general example of a state machine process 200 for automatically determining a volleyball statistic to record in a user interface according to an exemplary embodiment. The exemplary embodiment shown, for sake of brevity, is just a small subset of a full state machine. The diagram is only showing the interaction between the “Serve” and “Receive” actions as an example of steps undertaken by an overall state machine. The process 200 uses the tap/click location on the virtual court to make decisions on what stats to record and what state to progress to next. The process generally begins from a current state 205. When a user interaction with the UI is detected, the process may determine 210 the location of the play/action. As a safeguard, the process may check 215 whether the registered interaction was a valid location in the UI to avoid inaccurate statistics from being input and/or confusing the system. In an exemplary embodiment, the location on the virtual court tapped/clicked by the user may be identified 220 as being on the same side of the court as the last act, identified 225 as being in-bounds on the opponent's side of the court, identified 230 as being out of bounds on the opponent's side of the court, or identified 235 as being a net-based act (either side of the court). Based on the court location of the current state, a finite number of possible volleyball acts (states) may occur. The state machine process determines which act is available and automatically records 240 the statistic until an end of rally condition arises 245, a point is awarded 255 and a serve state commences 260. A serve state refers to the beginning of a gameplay sequence where a team serves the ball to the other team. If an end of a rally condition is not present, then the process may loop back 250 to the beginning for the next state. There are a limited number of possible states in a volleyball rally. For example:

Start

Serve

Receive

First Ball

Second Ball

Third Ball

Defense

Free Ball

Put Back

Overpass

Block

Point

Each one of these states will lead to exactly one subsequent state depending on the location of the ball. The following are some examples:

Serve State->(ball lands out of bounds)->Point State (Error to server, point to opponent)->Serve State (opposing team).

Third Ball State (attack)->(ball lands in-bounds opposing side)->Point State (award Kill, point to attacking team)->Serve State (attacking team).

The state machine required to represent all possible paths through a volleyball rally is very complex, requiring several hundred decision branches. But it is finite and indeed possible to implement in statistics software.

FIG. 9 shows an example of a state machine transition process 300 for automatically determining transitions between volleyball actions for recording statistics in the UI background according to one embodiment. In this case, the state machine starts in the serve state 305. The user may register 310 an interaction (tap/click) on the virtual court which automatically results in the possible outcomes, stats recorded, and state transitions. As will be understood, several of these sub-processes may be integrated to provide the overall state machine. For example, the process may determine 315 if the location registered was in a service area. If not, then the process may recognize the registration as being an invalid touch of the UI because it does not appear to be identifying a serve and the process restarts. If the registration was in the service area, then the process may recognize 320 the registration as identifying a serve action. The process may record 325 a serve attempt and may proceed to wait until the user registers a subsequent touch of the virtual court. The process may determine 335 whether the subsequent touch was on the same court side as the origin of the serve. If so, the process may record an invalid serve statistic and return to the serve state 320. If the touch after the serve was not on the same side as the serve origin, the process may select from a number of state possibilities what the next location of the subsequent touch represents. For example, the process may determine one of three possible states for a touch after a serve: a location representing 340 the ball was in the opponent's side of the court and in-bounds; a location representing 370 the ball was in the opponent's side of the court and out-of-bounds; or a location representing 375 the ball was hit into the net. In response to the process determining the location represents 340, the ball being in-bounds, the process may determine 345 whether the location represents whether the ball hit the court surface. If the ball did not hit the court surface, then a process related to a receive state 350 may be triggered which may determine a finite series of actions available in response to a player receiving the ball (for example, a dig, a pass, a return volley, an out-of-bounds hit, etc.). For sake of illustration, the process for determining acts beyond a receive act and their statistics is not described because of the many additional actions that may occur. If the ball was determined to have hit the court surface, then the process may record 355 an ace and a statistic for serve rating for the serving player, record 360 a receiving error for a player on the receiving side of the court and a pass rating statistic, and record 365 a point for the serving team. Once the process determines that an event signifies a dead ball, then the process may restart at the serve state 305.

When the aspect of the state machine is combined with the virtual court, it will be appreciated that this approach provides an intuitive, user friendly and entirely different approach than anything previously done for volleyball record keeping. Once correctly implemented, the state machine may be guaranteed to produce consistent, accurate statistics. As will be appreciated, if the user were to do nothing other than tap on the court for every ball contact and select the correct player, they could be recording statistics accurate enough to be fully compliant with the most stringent standards for statistics recording. And they would be recording more data than is available from virtually any current volleyball statistic solution.

The RallyFlow system may track progress through this state machine at all times during the rally. The current state, combined with the location of the ball and the identity of the associated player, may be all the system needs to generate complete statistics.

The RallyFlow state machine embodiments cover for example, the entire NCAA volleyball statistic rules specification. The processes can be easily adapted to support rules specifications of other governing bodies (FIVB, NFHS, etc.). This is without the user having to know anything about the intricacies of these rules. Because the complexities of the statistic rules are handled internally, the user will almost certainly record more accurate statistics than with any other method. And the statistics will be entirely consistent between any statistician, team, or league using the RallyFlow system.

As will be further appreciated, there are a number of other unique advantages of the embodiments disclosed:

Location Information: Every data point may include location information. Other volleyball statistic solutions do not record location information at all. Others may record location as a separate, discrete data input, which can be extremely difficult to input at real-time pace along with other statistical pieces of data. Embodiments of the subject technology have location information available inherently. Location is valuable for almost all sports statistics (e.g., basketball shot charts, etc.), and is especially valuable for volleyball. This location information may be used to generate charts such as shot charts and court area charts.

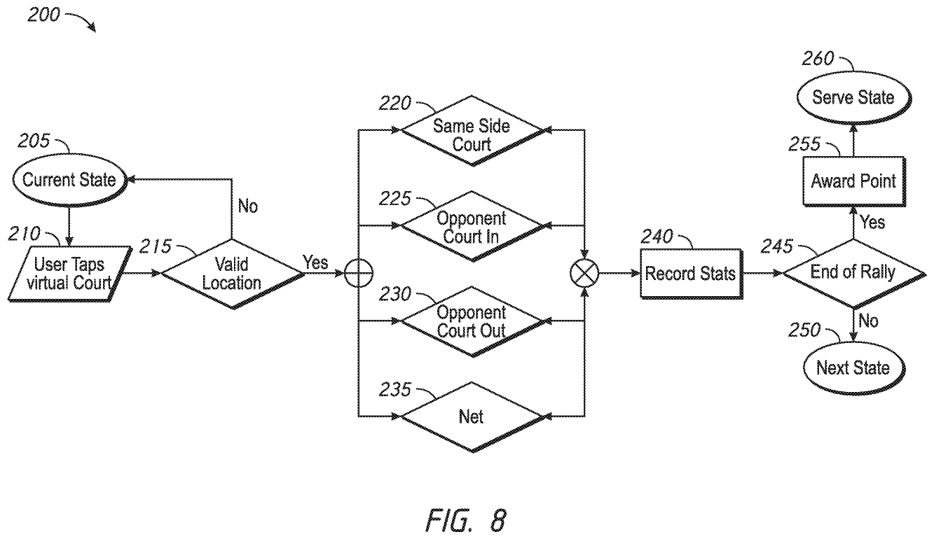

FIG. 10 for example, shows a general shot chart displayed in the UI 100 of two locations 410 and 420 related to actions. The action at location 410 resulted in a subsequent action at location 415. The action at location 420 resulted in a subsequent action at location 425. As will be understood, these two actions may not necessarily be related to one sequence of plays.

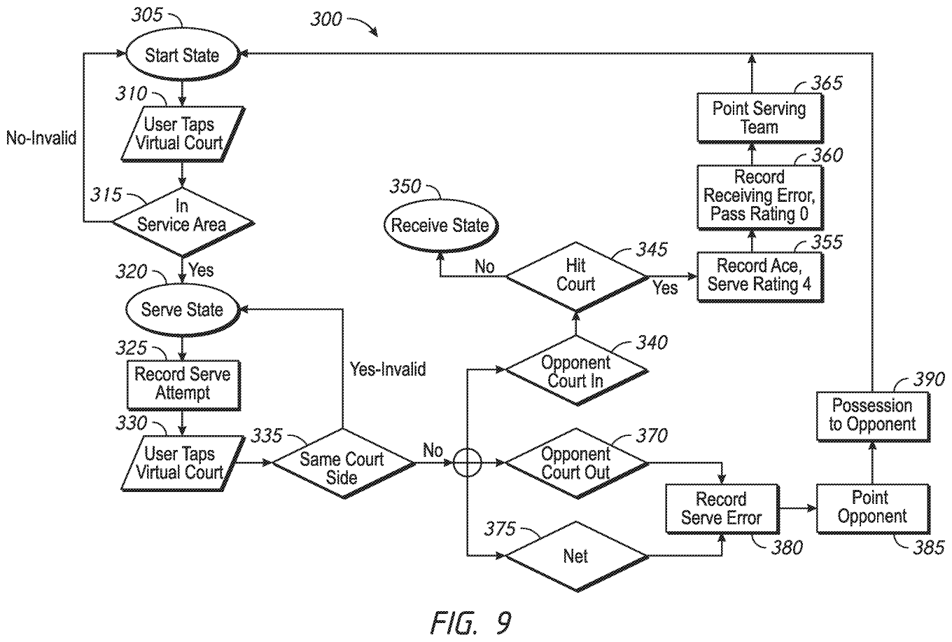

FIG. 11 shows an area chart 500 which shows the hitting percentage statistic for a player broken down by area of the court. The hitting percentage may be based on hitting statistics recorded for each region shown. For example, the hitting percentage may be calculated by subtracting the total number of hitting errors recorded from the total number of kills recorded for a virtual court region and dividing that by the total number of attack attempts in the virtual court region. In some embodiments, the virtual court may be divided into sides 510 and 520. For side 510, the player's hitting percentage statistics may be displayed for the front row 540 divided up into the left side, center, and right side of the row. The player's hitting percentage statistics may also be displayed for the back row 530 divided up into the left side, center, and right side of the row. This allows the coach and player to see where the player is most effectively hitting and where they need to improve. Almost all of the recorded statistics can be displayed by area in this way. These charts are essential for coaches and players to see exactly where they are earning or losing points, as well as the strengths and weaknesses of the opponent. The location information can also enable functionality such as automatic pass quality ratings based on the location of the pass.

Every Contact Recorded—In the system, every ball contact may be recorded, not just the ones tied to traditional statistics. This enables valuable statistics such as defensive touches, or block attempts, that would otherwise go unreported. And because every ball contact in the system has location information, this enables location charts for actions like passes and sets beyond the traditional serve and attack charts.

Record Both Teams—The system is inherently able to record statistics for both teams on the court. Most mobile statistic software solutions record stats for only one team. This is primarily due to the limited screen real estate of mobile devices. Recording stats for both teams would typically require either constantly switching the interface between the two teams or doubling the already high number of buttons. Neither solution is viable for fast paced recording. Because the system has the full court available at all times, and dynamically generates the player select list, both teams can be recorded with no additional screen real estate or buttons required.

Accurate Video Sync—An increasingly common use of volleyball statistics is to synchronize them with a video recording of the match. This allows a coach or player to jump directly to a particular serve, pass, or error, etc. in the video. However, the accuracy of the video offset is often compromised by the limitations of current recording mechanisms. Most current input methods require that the statistician to wait for the result of an action before recording that action. For example, the statistician would have to wait to see if the serve resulted in an ace before recording the serve action. This can in some cases involve a delay of several seconds between the recording of the action and when in it actually occurred in real-time. But because the system records every ball contact at the exact time of contact, this delay is avoided. This significantly improves the accuracy of synchronizing with video.

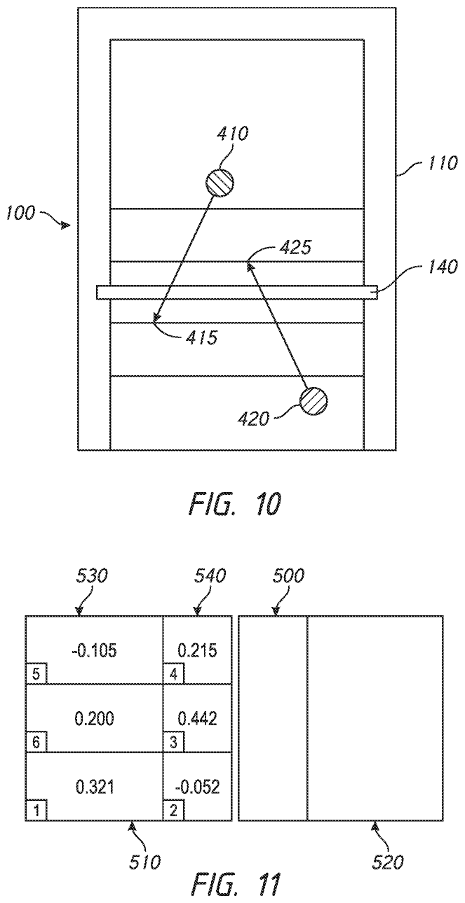

Net: The virtual court 110 interface includes additional features designed to further improved accuracy and usability. Referring now to FIG. 12, aspects of statistics related to actions proximate the block zone 145 are shown according to exemplary embodiments. The virtual court 110 is shown in partial view focused on the block zone 145 in FIG. 12. Similar to the in-bounds and out-of-bounds court areas, the virtual net 140 itself and the block zone 145 are tappable areas/features in the interface. If the user taps the net 140, the tap indicates that a serve or hit went into the net 140 and did not go over. This may be handled by the state machine as an error attributed to the player initiating the ball contact. In some embodiments, tap zones for the antennae (not shown) can be provided at each end of the net 140 in order to distinguish antennae errors from net errors. As will be appreciated, this is another example of eliminating the need for separate buttons in the UI to record statistics. The court area itself represents based on the possibilities in the state machine what just occurred in gameplay with a single tap.

Block Zone—The block zone 145 is a special area near the net 140 that can be used to distinguish a block from an attack, dig, or other play close to the net 140. If the user taps in the block zone 145, the state machine may know to branch to the block action rather than attack or dig actions. The block zone 145 may be a translucent overlay, or similar interface element, on either side of the net 140. The block zone 145 for each side only needs to be shown when blocking is relevant and may be hidden from view otherwise.

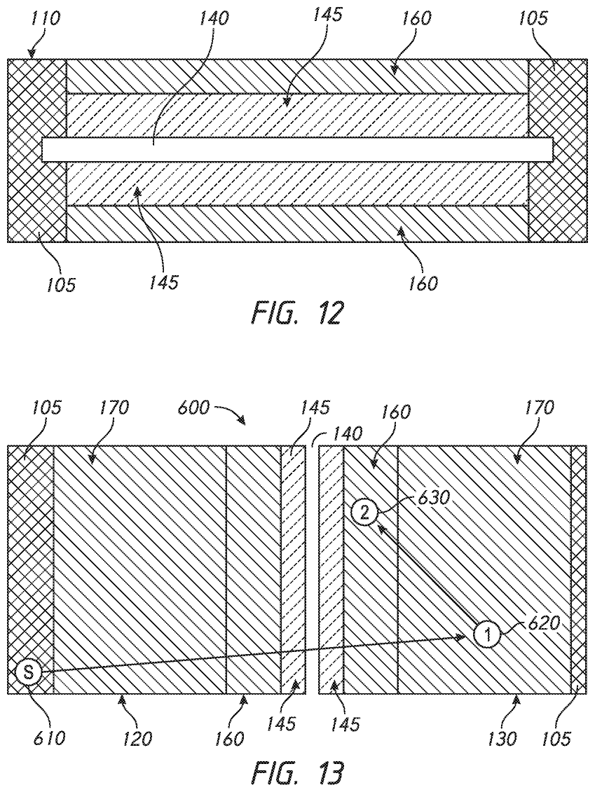

Visual History—A visual history of actions can be displayed on the court to give the user context as to what is currently happening as well as the most recent actions. This is particularly useful when used in combination with undo functionality. The history can be displayed in a variety of ways including markers indicating the location and action type for each ball contact. FIG. 13 for example, shows an embodiment of a user interface 600. The user interface 600 may be the same as the user interface 100 except that a sequence of tapped locations 610, 620, and 630 are maintained in view. FIG. 13 is showing a serve at tapped location 610 by Team A (left side) which travels over the net 140 into the back row 170 of side 130 (Team B's side). The serve is marked as passed by Team B at location 620 followed by a set in the front row 160 marked at location 630 by Team B. This would then typically be followed by a hit by Team B, then defense by Team A, etc. The last 3 contacts may be shown and may include directional arrows and numbers indicating the hit order in the sequence so that the user has context of where they are within the rally, but the number of contacts shown is fully configurable. Providing context in this manner is an improvement over an interface showing only a blank court for each contact, which would make it very difficult for the user to look away from the screen, then look back, and accurately track and record the sequence.

Machine Learning

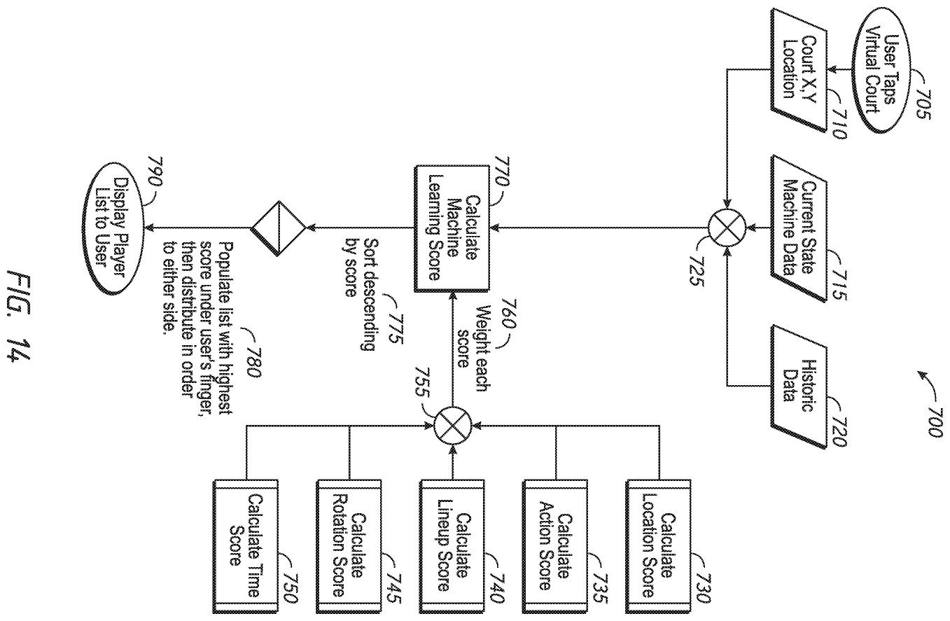

In some embodiments, the state machine is able to immediately generate accurate statistics without any machine learning. However, some embodiments may include machine learning to help speed player selection for the user by identifying the most likely player related to an action. FIG. 14 shows a machine learning process 700 for identifying the most likely player involved for an action related to the area of the court tapped/clicked 705. This makes player selection as fast as possible for the user. An embodiment of the machine learning process looks at past data to predict the most likely player for any given action. A number of variables are used in the machine learning process to arrive at an accurate prediction. The process 700 shown uses a few variables as an exemplary embodiment, however as discussed below, more variable may be used. In response to the user touching 705 the virtual court, the process may retrieve from computing memory, a current location 710 on the virtual court, current state machine data 715, and historical data 720. The aggregate 225 of data collected may be forwarded to a processor which calculates 770 the machine learning score. In some embodiments, additional variables may be scored to augment the accuracy of the machine learning score to more accurately predict which player most likely performed the action.

The following is a list of variables that may be used in an exemplary embodiment of the machine learning aspect. As will be understood, the variables described are examples only and the processes may use only some of these variables or may be expanded to include additional variables.

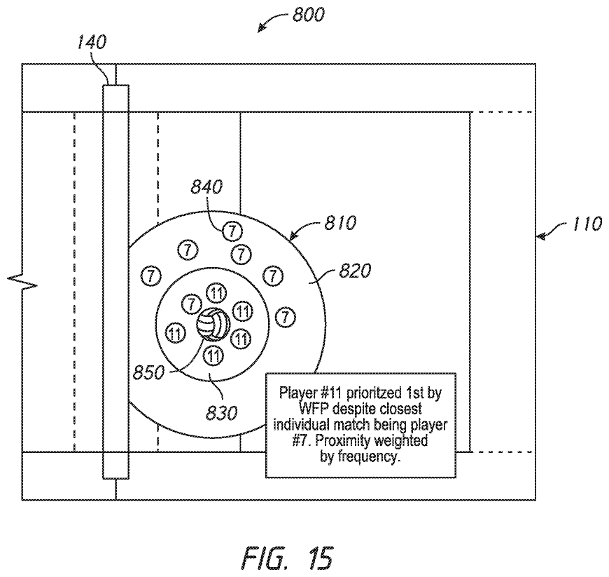

Location: In one embodiment, the most heavily weighted variable may be court location 710. For any given volleyball action and lineup rotation, any previous data points in close proximity to the same location as the user's current tap are strongly considered. The player the user wants to select for the current event will likely be the same as in previous similarly located events. FIG. 15 shows a diagram representing a chart of which player may be prioritized in player selection display based on weighted data. Each player may have a court location score 730 calculated which may be based on for example, their previous location on an immediately previous action.

Action: Data points from the same state machine action as the current action (e.g., Attack, Set, etc.) may be heavily weighted in calculating an action score 735.

Rotation: Data points from the same lineup rotation number may be heavily weighted in calculating a rotation score 745. Other rotations may still be considered, but to a lesser degree.

Time: More recent data points (e.g., from the same set or match) may be favored most heavily in calculating a time score 750. But older data points can still be used if other variables make them relevant.

Lineup: Data points where the same six players were on the court in the same order may be more heavily weighted in calculating a lineup score 740.

In all cases, the quantity of historic data points with heavily weighted variables are usually strongly considered before other weighted variables. A single lone data point should not outweigh a large number of other, slightly lower weighted, data points. Together, the weighted score 760 of all of these variables from the historic data points may be fed 755 into the machine learning calculation 770. A simple algorithm such as Weighted Sum Model can be used for the prediction. However, any number of predictive algorithms such as Linear Regression, Naive Bayes, K-Nearest Neighbor, etc. can be used.

The result of running the algorithm is a list of players sorted in order of prediction confidence. That is, sorted 775 for display in the order that the user is most likely to choose each player given historic patterns. Embodiments of the interface then take this sorted list and display it spread around the tap location of the user, for example as shown in the user interface 800 of FIG. 15. The Figure shows an embodiment with a marker (graphic of a volleyball) 850 indicating a location of last action. A pop-up graphic 810 shows two regions 820 and 830 of the most likely players to have performed the last action. As shown, two players 840 (represented by uniform numbers “7” and “11”) are displayed in various degrees of proximity and frequency to the marker 850 based on the priority results of the machine learning process described.

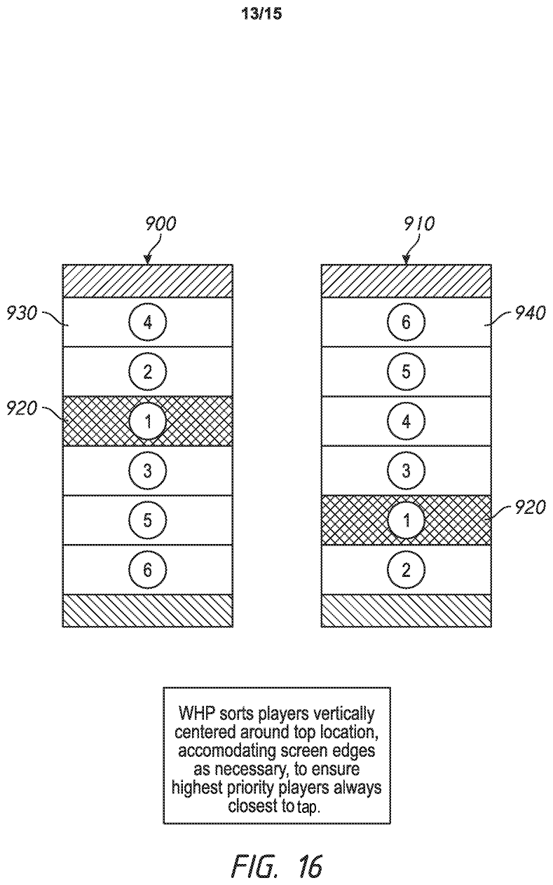

FIG. 16 (with concurrent reference still to FIG. 14), shows examples of player lists 900 and 910 generated 780 based on the confidence prediction of the machine learning process embodiments. The highest confidence prediction may be displayed immediately under the user's finger. For example, player “1” represented by box 920 represents the player with the highest confidence score which may be immediately positioned under the user's finger. Less confident predictions may then be spread out further away from the user's finger (for example, boxes 930 and 940) in the display step 790.

As will be appreciated, aspects of the process ensure, with very high likelihood, that the desired player will be either immediately below the user's finger or within 1-2 menu rows. Current implementations of the process place the desired player immediately below the finger greater than 75% of the time. The prediction is within one row to either side of the finger greater than 90% of the time. Prediction accuracy will continue to improve as the algorithm is further developed.

Statistics measuring the difference between the prediction and the value the user actually selects are tracked and can be fed back into the machine learning algorithm to further improve accuracy. Given the nature of machine learning algorithms, the accuracy of the prediction will also increase for each user over time as the algorithm is “trained” with historic data.

The machine learning algorithm can be applied to either the full roster of players or only the six players currently on the court. There are pros and cons to each:

Full Roster: Decreases prediction accuracy of the algorithm because all players on the roster must be considered. Display of the full list will also require scrolling on smaller device screens. These two factors can significantly decrease data entry speed. However, the full roster approach does not require the user enter a starting lineup or track substitutions and libero swaps.

Court Six Only: Significantly increases the accuracy of the algorithm, given that it is known which six players are on the court at any time. The player menu can also be presented without the need for scrolling, further improving speed. However, the user must ensure that the six players on the court are accurate at all times. This means tracking the starting lineup as well as player substitutions and libero swaps.

Tap and Drag Mechanic

In some embodiments, the system may use further interface optimization to improve statistic recording speed and accuracy. Normally, the user would need to tap or click for each piece of information being entered. At minimum, this is one tap/click for selecting the player. Entering multiple layers of information such as shot type, serve rating, etc., would require an additional tap for each piece of information. This could require as many as 4-5 taps for one data point entry. This tap, release, tap, release, tap, release mechanic is often impossible at full speed during the match since another volleyball action has occurred less than a second apart from the previous one.

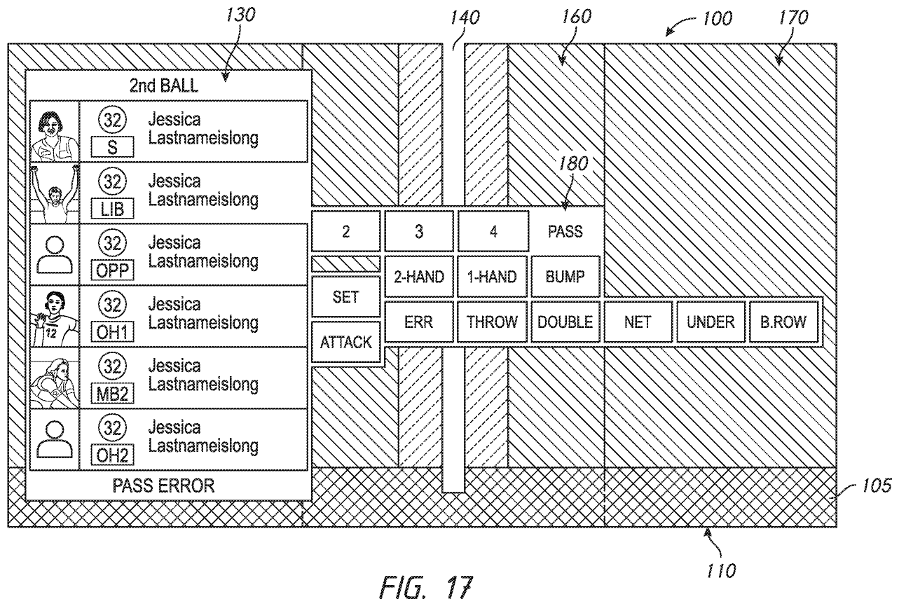

As will be appreciated, an embodiment of the system instead generates a tap and drag mechanic that allows a user to make multiple selections with a single tap and stroke sequence. FIG. 17 shows a screenshot of a UI 100 overlay 180 based on an exemplary embodiment of the tap and drag mechanic described. The UI 100 includes the same features previously described, which will not be re-described unless needed for sake of brevity. The tap and drag feature allows the user to select the player and optionally provide additional information such as a pass quality rating or hit type (tip, dump, etc.) in a single smooth drag rather than requiring multiple, independent taps. Embodiments will select defaults for each level of data input. For example, tapping a court location generated a player by default (which may be based on the machine learning aspects described above) and then a series of prioritized actions/results were generated in the overlay 180 for display in connection to the player. If the user wants to accept the default, they only need to lift their finger in some embodiments to register the selection. Otherwise, the user may drag out to make changes in one smooth action, then release their finger as they reach the desired result. The user is still selecting as many pieces of information, but the number of taps/clicks may be reduced to one. The tap and drag mechanic can be turned on/off given the preference of each user. The menus showing the additional layers of information can also be enabled/disabled as needed.

Referring now to FIG. 18, a schematic of an example of a computer system/server 10 is shown. The computer system/server 10 is shown in the form of a general-purpose computing device. The computer system/server 10 may serve the role as the machine implementing for example the functions of providing a software application and user interface on mobile computing devices or may serve the role as the machine hosting a server for managing user accounts and receiving/managing uploaded statistics. The components of the computer system/server 10 may include, but are not limited to, one or more processors or processing units 16, a system memory 28, and a bus 18 that couples various system components including the system memory 28 to the processor 16.

The computer system/server 10 may perform functions as different machine types depending on the role in the system the function is related to. For example, as a mobile computing device providing a user interface to record statistics, the computer system 10 may be for example, mobile telephone devices, tablet devices, wearable computing devices (including for example, smart watches, smart glasses, and smart jewelry). In some embodiments, video captured by one of the aforementioned mobile devices may be uploaded to a home/stationary computing device, which is accessing a website version of the platform. A home/stationary computing device may be for example, personal desktop computers, handheld or laptop devices, set top boxes, or programmable consumer electronics. As a host server for managing an online portal related to statistics archiving and providing accessible through the mobile software application or through the website, the computer system/server 10 may be for example, server computer systems, multiprocessor systems, microprocessor-based systems, network PCs, and distributed cloud computing environments that include any of the above systems or devices, and the like.

The computer system/server 10 may be described in the general context of computer system executable instructions, such as program modules, being executed by a computer system (described for example, below). In some embodiments, the computer system/server 10 may be a cloud computing node connected to a cloud computing network (not shown). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described above and herein.

The computer system/server 10 may also communicate with one or more external, integrated, or peripheral devices 14 such as a camera, a keyboard, a pointing device, a display 24 (which may be in some embodiments a touch sensitive or tactile display), etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer program product for generating a user interface (UI) for rapid entry of volleyball statistics in real-time, the computer program product comprising a non-transitory computer readable storage medium having computer readable program code embodied therewith, the computer readable program code being configured, when executed by a processor, to:
provide the UI on a computing device with an electronic display;
generate a virtual court area in the UI, the virtual court area representing a virtual volleyball court;
identify an input in the electronic display received from a user, of a location in the virtual volleyball court touched by the user, wherein the location in the virtual volleyball court corresponds to a real-life location of a volleyball play on a real-life volleyball court;
determine by the processor, a volleyball action, from a set of finite volleyball actions possible at the location in the virtual volleyball court touched by the user; and
automatically record a volleyball statistic for the determined volleyball action.

2. The computer program product of claim 1, further comprising computer readable code configured to:
determine a player associated with the determined volleyball action; and
associate the recorded volleyball statistic with the determined player.

3. The computer program product of claim 1, further comprising computer readable code configured to:
determine by a state machine a prioritized list of players at the location in the virtual volleyball court touched by the user;
display in the UI, the prioritized list of players at the location in the virtual volleyball court touched by the user; and
register a selection of one of the players by the user.

4. The computer program product of claim 3, wherein the displayed prioritized list of players is displayed under a location on the UI under a finger of the user.

5. The computer program product of claim 1, wherein:
the virtual volleyball court is divided up into a plurality of demarcated areas representing real-life areas of the real-life volleyball court; and
the set of finite volleyball actions possible at the location in the virtual volleyball court touched by the user is based on real-life volleyball actions possible in each of the real-life areas of the real-life volleyball court.

6. The computer program product of claim 1, further comprising computer readable code configured to:
generate an overlay positioned over the location in the virtual volleyball court touched by the user, the overlay displaying a list of selectable volleyball actions.

7. The computer program product of claim 6, wherein the overlay is configured to be displayed on the UI by the user dragging a finger across a section of the UI.

8. A method for generating a user interface (UI) for rapid entry of volleyball statistics in real-time, comprising:
providing the UI on a computing device with an electronic display;
generating a virtual court area in the UI, the virtual court area representing a virtual volleyball court;
identifying an input in the electronic display received from a user, of a location in the virtual volleyball court touched by the user wherein the location in the virtual volleyball court corresponds to a real-life location of a volleyball play on a real-life volleyball court;
determining by the processor, a volleyball action, from a set of finite volleyball actions possible at the location in the virtual volleyball court touched by the user; and
automatically recording a volleyball statistic for the determined volleyball action.

9. The method of claim 8, further comprising:
determine a player associated with the determined volleyball action; and
associate the recorded volleyball statistic with the determined player.

10. The method of claim 8, further comprising:
determining by a state machine a prioritized list of players at the location in the virtual volleyball court touched by the user;
displaying in the UI, the prioritized list of players at the location in the virtual volleyball court touched by the user; and
registering a selection of one of the players by the user.

11. The method of claim 10, wherein the displayed prioritized list of players is displayed under a location on the UI under a finger of the user.

12. The method of claim 8, wherein:
the virtual volleyball court is divided up into a plurality of demarcated areas representing real-life areas of the real-life volleyball court; and
the set of finite volleyball actions possible at the location in the virtual volleyball court touched by the user is based on real-life volleyball actions possible in each of the real-life areas of the real-life volleyball court.

13. The method of claim 8, further comprising:
generating an overlay positioned over the location in the virtual volleyball court touched by the user, the overlay displaying a list of selectable volleyball actions.

14. The method of claim 13, wherein the overlay is configured to be displayed on the UI by the user dragging a finger across a section of the UI.
